(19) United States
(12) Patent Application Publication
(10) Pub. No.: US 2008/0106035 A1
(43) Pub. Date: May 8, 2008

(54) WAGERING CASINO GAME

(76) Inventor: T. Christian A. Schlumbrecht, New Orleans, LA (US)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 11/856,942

(22) Filed: Sep. 18, 2007

Related U.S. Application Data
(60) Provisional application No. 60/864,912, filed on Nov. 8, 2006.

(51) Int. Cl. G07C 15/00

(52) U.S. Cl. 273/144 B

(57) ABSTRACT

A casino game comprising one or more sets of game pieces and a layout which designates various wagering areas. The object of the game being to make a good wager based on a randomized event related to the set of game pieces. The preferred game apparatus includes a single set of game pieces which are tiles with black and white sides, and a layout that provides wagering areas.

### CROSS-REFERENCE TO RELATED APPLICATIONS

Priority of U.S. patent application Ser. No. 60/864,912, filed Nov. 8, 2006, is hereby claimed. This application is incorporated herein by reference.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND

The present invention relates to methods for playing a casino game wagering on the outcome of random and/or unknown events, such as the outcome of a game pieces and/or tiles shake and/or throw. More particularly, the present invention relates to a method and apparatus for playing a casino wagering game using game pieces such as tiles or cards with different outcome indicia.

While certain novel features of this invention shown and described below are pointed out in the annexed claims, the invention is not intended to be limited to the details specified, since a person of ordinary skill in the relevant art will understand that various omissions, modifications, substitutions and changes in the forms and details of the device illustrated and in its operation may be made without departing in anyway from the spirit of the present invention. No feature of the invention is critical or essential unless it is expressly stated as being “critical” or “essential.”

### BRIEF SUMMARY

The method and apparatus of the present invention solves the problems confronted in the art in a simple and straightforward manner. What is provided is a new casino game of Shake Plate or Lio Pai where players wager against random outcomes regarding a set of game pieces (including but not limited to tiles and/or cards), and providing a quick revelation of the final game result.

In a live table game format, the players each make selected wager(s). The game pieces are randomized, and the outcome is determined to select winning and losing wagers.

In one embodiment is provided a method and apparatus for a gambling game which is played using a set of game pieces where each game piece has a plurality of possible outcomes. In one embodiment each game piece has two possible outcomes (first and second outcomes) and a plurality of these game pieces increases the number of possible final outcomes for the entire set of randomized game pieces. In one embodiment each game piece can be a tile having two sides of first and second indicia, such as first and second colors (e.g., white and black).

In one embodiment, to choose from during game play, players will have a set of wagers and/or bets regarding the randomized outcome of the set of game pieces. During each round of play, players can select bets from one or more bets contained in the set of allowed wagers and/or bets. In one embodiment multiple bets or wagers are allowed for each player, including the possibility of making inconsistent bets or wagers. In one embodiment only a single bet or wager for each player is allowable. In one embodiment, after an opportunity to make a first set of bets or wagers, final bets will be called and game play will start.

### General Method

In one embodiment, the method and apparatus begins with each player making a wager or set of wagers on a result regarding a random outcome from a plurality of game pieces, each game piece having a plurality of possible indicia. If a player's wager(s) is designated a winning outcome, the player receives a payoff based upon his wager(s) and if the outcome is a losing outcome, the player's wager(s) are lost. In one embodiment wagers are resolved by comparing the wagers placed to the event of the outcome.

In one embodiment the method includes the following steps: (a) providing a game table, the game table having a plurality of game pieces which can provide a random outcome; (b) players placing different wagers on the table by betting on the outcome of the game pieces; (c) shaking/shuffling the game pieces; (d) and revealing the outcome of the shake; (e) collecting losing wagers; and (f) paying winning wagers.

In one embodiment a last bet call is made between steps “c” and “d”. In one embodiment the last bet call is the last chance to make bets.

In one embodiment a last bet call is performed between steps “b” and “c”. In one embodiment the last bet call is the last chance to make bets.

In one embodiment step “e” is performed before step “f.” In one embodiment step “f” is performed before step “e.”

In one embodiment the method includes an additional step “g” of collecting the game pieces for another round of play.

In one embodiment in step “d” the game pieces are placed on the table. In one embodiment a top is removed from the shaking plate to reveal the game pieces.

In one embodiment in step “d” the game pieces can be organized in groups of similar indicia. In one embodiment the groups can be separated from each other.

In one embodiment the outcome of the game pieces can be called out. In one embodiment a winner can be declared.

In one embodiment the method includes the following steps: (a) participating players placing their desired bets; (b) randomizing (preferably by shaking/shuffling) the game pieces (preferably six game pieces); (c) displaying the randomized game pieces having first and second indicia to reveal the winning outcome; (d) dealer(s) collecting all losing bets; (e) dealer(s) paying all outside winning bets; and (f) dealer(s) collecting the game pieces for the next round of play. In one embodiment last bets are called before displaying the game pieces. In one embodiment last bets are called before randomizing the game pieces. In one embodiment last bets are called after randomizing the game pieces but before displaying the game pieces.

In one embodiment the method includes the following steps: (a) participating players placing their desired bets; (b) calling for last bets and then dropping game pieces (preferably six tiles) on the table (preferably on the center) to reveal the winning outcome (in one embodiment the tiles can be dropped from a specialized shaker; (c) dealer(s) collecting all losing bets; (d) dealer(s) paying all outside winning bets (which can include White/black line, Tie Line and the Odd and Even Combo bets); (e) paying all winning place bets (which can include the specific tile combination bets and the all White/Black bets); and (f) the game pieces being collected and placed into a shaker in preparation of the next round of play.

### Game Pieces

In one embodiment the game pieces can be tiles with first and second indicia on their two sides, which are placed in a shaker, and shaken to obtain a random outcome for each round of play regarding the number of first and second indicia appearing after being shaken. In one embodiment the tiles can be monolithic or small rectangular or square in shape (such as those resembling conventionally available dominos). In one embodiment the tiles can have a first colored side (e.g., black) and a second colored side of a color different from the first colored side (e.g., white).

In one embodiment there are six tiles black in color in one side and white in color on the other side.

In one embodiment an even number of total game pieces can be used. In one embodiment an odd number of total game pieces can be used. In one embodiment 2, 3, 4, 5, 6, 7, 8, 9, 10, 11, 12, 13, 14, 15, 16, 17, 18, 19, 20, 21, 22, 23, 24, 25, or more game pieces can be used. In various embodiments the total number of game pieces used can vary within the range between any two of the above listed set of total number of game pieces. In a preferred embodiment six game pieces are used having first and second indicia for first and second possible outcomes regarding each game piece.

In one embodiment the game pieces can be cards with indicia on first and second sides.

### Randomization Event

In various embodiments the game pieces can be randomized to obtain a random event displayed by the resulting indicia on the game pieces after the randomization event. In one embodiment, the randomization event can be obtained by shaking the game pieces in a container called a shaker. In one embodiment the game pieces (e.g., tiles) can be shaken and then exposed to provide the outcome. In one embodiment the shaker is a housing for the game pieces or tiles or game pieces to be shaken which housing can be covered to hide the outcome of the game pieces until desired. In one embodiment the games pieces (e.g., cards) are shuffled to make them randomized.

In one embodiment a designated person for shaking the game pieces can place the game pieces in a container called a shake plate, cover the shake plate, and then shake the shake plate and game pieces for obtaining the random outcome. In one embodiment these activities can be done at a table.

In one embodiment, for the shaking process, the designated person will put the shaker flat on the table and uncover the game pieces. In one embodiment the game pieces can them be arranged (such as by the dealer) in groups of like indicia (such as groups of like color—e.g., black and white being separated from each other). A person (such as the dealer or proctor) can then call out the total number of first and second indicia for the game pieces, and then declare a winner.

In one embodiment the outcome of the game pieces with first and second indicia can be displayed on a plate. In one embodiment the display plate can be a round or square shape. In one embodiment the plate can be comprised of wood or plastic.

In one embodiment person designated to shake the pieces is called a shaker. In one embodiment a designated person at the table can shake the game pieces to obtain the designated outcome.

In one embodiment the person designated to shake the game pieces is a dealer.

In one embodiment the person designated to shake the game pieces is not a player or a dealer.

In one embodiment a shaker who is not a dealer shakes the game pieces. In one embodiment the shaker is responsible for supervising the dealer or dealers. In one embodiment the designated person for shaking the game pieces is a game proctor.

In one embodiment person designated to shake the game pieces is a participating player. In one embodiment a random selection process is used to select the person designated to shake the game pieces. In one embodiment a rotational selection method is used to designate the person to shake the game pieces.

In one embodiment the designated person for shaking is randomly chosen from the game proctor and the set of players. In one embodiment a posted selection scheme is used for selecting the designated shaker from either the set of players, or from the proctor and the set of players. In one embodiment the players themselves can select the designated person for shaking, such as by majority vote.

In one embodiment an automatic shaker is used to shake the game pieces. In one embodiment a computer is used to emulate a random outcome of the shaking of a set of game pieces. In one embodiment a display is used to display the result of the shaking of the set of game pieces. In one embodiment a video display is used to display the result of the shaking of the set of game pieces.

### Allowable Bets and Various Payouts

In one embodiment the players are allowed to make different bets as to the randomized outcome of the game pieces. In one embodiment there are multiple bets for players to choose from for each round of play. In one embodiment, players can make bets from even money payouts to proposition bets for the exact outcome of tiles. In one embodiment allowable bets include outside bets, Odd/Even Combination bets, and specific proposition bets.

In one embodiment at least the following bets are allowed: (a) majority bet where the wager is that a majority of a first indicia (or a majority of a second indicia) will occur in the game pieces; (b) tie bet where the wager is that the same number of a first indicia will occur as that of a second indicia in the game pieces (i.e., a tie between indicia such as the same number of a first color appears as that of a second color); (c) Odd/Even Combo bet where the wager is that an even (or odd) number of a particular indicia will occur in the game pieces (e.g., four white and two black game pieces for an even wager); and (d) Proposition Bet where the wager selects a particular number of a first (and/or a particular number of a second) indicia tp occur in the game pieces (e.g, 1 white and five black game pieces). In one embodiment at most the above referenced bets are allowed.

In one embodiment, where an even total number of game pieces (each game piece having first and second indicia) is used, then an even bet wagers that an even number of first indicia (e.g., white tiles) and an even number of second indicia (e.g., black tiles) will occur. In one embodiment, where an odd total number of game pieces is used, then an even bet on first indicia wagers that an even number of first indicia (e.g., white tiles) and an odd number of second indicia (e.g., black tiles) will occur; and an even bet on second indicia (e.g., black) wagers that an even number of second indicia (e.g., black) will occur along with an odd number of first indicia (e.g., white tiles).

In one embodiment, where an odd total number of game pieces is used, then an odd bet on first indicia wagers that an odd number of first indicia (e.g., white tiles) and an even number of second indicia (e.g., black tiles) will occur; and an odd bet on second indicia (e.g., black) wagers that an odd number of second indicia (e.g., black) will occur along with an even number of first indicia (e.g., white). Accordingly, using an odd number of game pieces increases the odd/even betting options as now the players can bet on a particular indicia—first or second being odd. However, using an odd number of game pieces would remove the ability to obtain a tie between first and second indicia for the game pieces.

In one embodiment at least the following bets are allowed: (a) majority bet where the wager is that a majority of a first indicia (or a majority of a second indicia) will occur in the game pieces; (b) tie bet where the wager is that the same number of a first indicia will occur as that of a second indicia in the game pieces (i.e., a tie between indicia such as the same number of a first color appears as that of a second color); (c) Odd/Even Combo bet where the wager is that specific even (or odd) number of either indicia will occur in the game pieces (e.g., four white and two black game pieces for an even wager); and (d) Proposition Bet where the wager selects a particular number of a first (and/or a particular number of a second) indicia to occur in the game pieces (e.g, 1 white and five black game pieces). In one embodiment at most the above referenced bets are allowed.

In one embodiment certain odd combination and even combination bets are allowed. For odd combination these can include at least the following sets of possible outcomes: 1 first or second indicia along with 5 second or first indicia. This covers two possible outcomes 1 first indicia and 5 second indicia or 1 second indicia and 5 first indicia. For even combination bets these can include at least the following sets of possible outcomes: 2 first or second indicia along with 4 second or first indicia. This covers two possible outcomes 2 first indicia and 4 second indicia or 2 second indicia along with 4 first indicia.

In one embodiment, certain “at least” bets or “more than” bets are allowed. These can include at least 1, 2, 3, 4, 5, of a first indicia will appear on the game pieces after the randomization event. These can also include at least 1, 2, 3, 4, 5, of a second indicia will appear on the game pieces after the randomization event.

In one embodiment, certain “range” bets are allowed. These can include a wager that, after the randomization event, the first indicia will appear between 1 and 6 game pieces, or between one or more of the following possible ranges: 2 and 6, 3 and 6, 4 and 6, and 5 and 6. These can include a wager that, after the randomization event, the second indicia will appear between 1 and 6 game pieces, or between one or more of the following possible ranges: 2 and 6, 3 and 6, 4 and 6, and 5 and 6.

In one embodiment, all players are required to place wagers of equal value regardless of the wager made. In one embodiment the amount of the wager is determined by house rules. In one embodiment the amount of the wager is displayed at the game table.

In one embodiment each player is required to place the same amount of wager. In one embodiment the amount of each player's wager can vary from another player's wager.

In one embodiment each player is given the option to increase his wager and require the other players to match, or the non-matching players will lose some or all of their wagers. In one embodiment, the raising and matching players can be granted some or all of the non-matching player's wagers.

In one embodiment different payouts are made for different winning wagers. For example, the payouts may be based on the odds of winning.

In one embodiment, a different payout scale is made for wagers made before the randomization even has occurred, than those made after the randomization event has occurred.

In one embodiment different payouts are made for the same winning wagers depending on the outcome of play.

In one embodiment a dealer is used to accept, collect, and payout on winning wagers. In one embodiment two dealers are used to accept, collect, and payout on winning wagers. In one embodiment one dealer is used to accept and collect wagers; and a second dealer is used to payout on winning wagers.

In one embodiment the person randomizing the game pieces (e.g., shaking them in the shake plate) will randomize the game pieces, and another person(s) (e.g., dealer(s)) will collect bets and payout winning bets. In one embodiment dealer(s) is/are responsible for paying all winning bets and collecting all losing bets.

After the wagers have been placed, the dealer or game proctor will call for final wagers and, if no more wagers are placed, the result of the game pieces will be revealed.

In one embodiment one or more bets can be allowed before a randomization event has occurred.

In one embodiment one or more bets can be allowed after the randomization event has occurred.

In one embodiment one or more bets can be allowed both before and after a randomization event has occurred.

In one embodiment a set of bets are allowed before the randomization event, and a second set of bets are allowed after the randomization event.

In one embodiment a the result of one or more of the game pieces can be displayed and the players are given the opportunity to increase their previously made wager. In one embodiment the payout for the increased amount of a wager is the same as that of the original wager. In one embodiment the payout is different (such as 1 to 1). In one embodiment the possible increased wager is limited (such as by the amount of the original wager).

### Table

In one embodiment the method and apparatus includes a table for playing a casino game. The apparatus includes a table having a playing surface/layout (cloth, table top or game board) and a result selector in the form of a set of game pieces or tiles with indicia.

In one embodiment a second area on the layout designates wagering areas for the reception of players' chips. Graphical indicia for different wagers signify the type of wagers the players make in the course of a round of the game. In one embodiment the multiple sets of graphical indicia for different wagers can be used. In one embodiment each player can have their own set of graphical indicia for the allowable different wagers.

In various embodiments the graphical indicia may appear in the form of geometric shapes such as rectangles, squares, parallelograms, polygons, circles, or other two dimensional shapes.

In one embodiment, the game can played on a blackjack style table with a single dealer. A set of game tiles can be used, the preferred embodiment being between 2 and 25 game pieces—most preferably 6 tiles. The game can be played with chips/counters of various denominations and/or cash.

The drawings constitute a part of this specification and include exemplary embodiments.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a top plan view of a preferred gaming table and layout.

FIG. 2 is a schematic of a preferred method.

FIG. 3 is a top plan view of an alternative gaming table and layout.

### DETAILED DESCRIPTION

Detailed descriptions of one or more preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in any appropriate system, structure or manner.

For simplicity a particular type of game piece will be used throughout the detailed description—that of a colored tile with one white side and one black side. However, this is not to be interpreted as limiting any various game pieces can be used along with various indicia. For example, first and second geometric shapes can be placed on either side of the tiles. As another example, numbers 1 and 2 can be placed on either side of the tiles. The main idea is to have two different possible indicia with each game piece.

### Shake the Plate

In one embodiment the players will have a plurality of wagers to choose from for game play. In one embodiment a plurality of colored tiles (e.g., 210, 220, 230, 240, 250, 260) having two sides (e.g., side A and side B) are included in a container or plate 200 which can be covered (e.g., by cover 205) and can be shaken to cause a random event in relation to the outcome of colors appearing in the plate when the cover is lifted.

### The Tiles

In one embodiment, the tiles can be rectangular, square, triangular, trapezoidal, parallelograms, polygonal, or some combination of these shapes. In one embodiment, the tiles can be of two colors, such as being Black on one side and White on the other, and resemble a domino.

In one embodiment, the tiles can be two sided but have varying color schemes. For example some of the tiles may be black and white, while others may be other colors, such as green and blue thereby providing a second tier of color variations. In one embodiment three or more tiers of color variations can be used (however, using additional color tiers provides more than first and second indicia and will increase the possible number of events and cause the possible bets to differ—for example one could bet that first and third indicia will tie whereas second indicia will not).

### The Plate

In one embodiment the plate 200 can be a small round or square shape made of wood, metal, polymer, or plastic in which the tiles (e.g., 210, 220, 230, 240, 250, 260) are placed and shaken for the outcome of each round of play.

In one embodiment a single color tier can be used (e.g., black on one side and white on the other side for each tile).

### The Wagers

Black/White Line 60 Bet: The black and white line is a wager for the outcome of most color tiles.

If there are more Black tiles than White tiles, the Black line will win and the White line will lose. If there are more White tiles than Black, the White line will win and the Black line will lose. The Black/White lines both lose when there is a Tie (e.g., 3 white tiles and 3 black tiles. The payouts can vary with the number of the winning color tiles:

### Black/White Line 60 Bet:

| #Tiles of the winning color | |
|---|---|
| the players bet on | Pay(to 1) |
| 6 | 6 |
| 5 | 3 |
| 4 | 1 |

### Below is a table providing the payouts and the probability of achieving a particular result.

| # Tiles of the winning | | | |
|---|---|---|---|
| color the players bet on | Pay | % Probability | % Return |
| 6 | 6 | 1.5625 | 9.3750 |
| 5 | 3 | 9.3750 | 28.1250 |
| 4 | 1 | 23.4375 | 23.4375 |
| Other | −1 | 65.6250 | −65.6250 |
| Total | | 100.0000 | −4.6875 |

The hit frequency is 34.38% and the house edge is 4.69%

For example, if a player bets the White line and 5 white tiles show up, then the player will be paid 3 to 1 and all players who bet the Black line will lose.

Tie Line 65 Bet: The tie line wagers will win when there are an equal number of Black and White tiles (for example 3 and 3). These wagers will lose if there is no tie. The winning bet is paid 2 to 1.

The tie bet wins 31.25% of the time. The house edge is 100%−31.25%×(2+1)=6.25%.

Odd/Even 70 Bet: The odd even wagers are determined by the number of winning color tiles. For example, if there are 4 Black tiles and 2 White tiles then Black is the winning color and 2 and 4 are even numbers. As another example, if there are 5 White tiles and 1 Black tile then White is the winning color and 5 and 1 are odd numbers.

For example, the Odd bet wins if the number of the winning color tiles is 5; it also wins if there are 3 white tiles and 3 black tiles. The winning Odd bet can pay 1 to 1 less a 5% commission. The Even bet wins 1 to 1 if the number of the winning color tiles is 4 of one color and 2 of the other color. The Even bet pushes if 6 white or 6 black tiles show up (a push means that the bet does not win or lose and the wager is returned to the player).

The Odd wager wins exactly 50% of the time and it pays 1 to 1 less a 5% commission. The house edge is simply 50%×5%=2.5%.

The Even wager wins 1 to 1 46.875% of the time, loses 50% of the time and pushes 3.125% of the time. The house edge is 50%−46.875%=3.13%.

In another embodiment the Even bet would loose if all black or all white shows up. In another embodiment the Even bet would win if all black or all white shows up.

All Black/All White 75 Bet: The All Black/All White wagers win if the color of the tiles are all the same color after the shake (e.g., all black or all white). This wager loses at all other times. The winning All Black wager pays 60 to 1. The winning All White wager pays 60 to 1.

### Mathematical Analysis:

The probability distribution of all possible outcomes when 6 tiles are shaken is shown

| Black Tiles | White Tiles | % Probability |
|---|---|---|
| 0 | 6 | 1.5625 |
| 1 | 5 | 9.3750 |
| 2 | 4 | 23.4375 |
| 3 | 3 | 31.2500 |
| 4 | 2 | 23.4375 |
| 5 | 1 | 9.3750 |
| 6 | 0 | 1.5625 |

The All Black bet wins 1.5625% of the time. The All White bet wins 1.5625% of the time. The house edge on either bet is 100%−1.5625%×(60+1)=4.69%.

Proposition Wagers 80:

The proposition wagers 80 are wagering on a specific outcome of the tiles after the randomization event (e.g., the shake).

For example: 4 Black, 2 White. Black wins the Black/White line because there are more Black tiles than White tiles. The 4 winning Black tiles are an even number so the Even wagers would win and the 4 Black 2 White proposition wagers would win. All other wagers would lose.

0 Black, 6 White Push Even/Odd Lose 0 White, 6 Black Push Even/Odd Lose

1 Black, 5 White Odd Wins 1 White, 5 Black Odd Wins

2 Black, 4 White Even Wins 2 White, 4 Black Even Wins

3 Black, 3 White Odd Wins

### Step-by-Step Round of Play

(1) Players make wagers (step 100).
(2) Dealer or proctor calls final wagers (step 110).
(3) Designated person shakes the plate (step 120).
(4) Dealer uncovers the plate (step 130).
(5) Dealer will declare a winning number and color (step 140).
(6) Dealer will collect all losing wagers starting from the White/Black line and working around the table (step 150).
(7) Dealer, starting from the White/Black line and working around, will pay all winning wagers (step 150).
(8) The dealer will then take the losing Proposition wagers and pay the winning proposition wagers at the center of the table (step 150).
(9) The dealer will then cover the plate and call for new wagers for the next round of play to begin (step 160).

### Alternatives

In one embodiment an even number of total game pieces are used. In one embodiment an odd number of total game pieces are used. In one embodiment 2, 3, 4, 5, 6, 7, 8, 9, 10, 11, 12, 13, 14, 15, 16, 17, 18, 19, 20, 21, 22, 23, 24, 25, or more game pieces are used. In various embodiments the total number of game pieces used can vary be between any selected two of the above listed total number of game pieces.

The indicia on game pieces or tiles are not limited to colors, and can include numbers or symbols. Additionally, the total number of tiles or game pieces are not limited to a set number. The tiles or game pieces used can be between about 2, 3, 4, 5, 6, 7, 8, 9, 10, 11, 12, 13, 14, 15, 16, 16, 17, 18, 19, 20, 21, 22, 23, 24, 25, or more tiles per round of play. However, odd numbers of game pieces will remove the tie bets. Increasing the number of game pieces will increase the number of possible proposition bets.

Bonus tiles, wild tiles, or Joker tiles can also be introduced to each round of play to expand the number of tiles in a round of play.

### Game Table

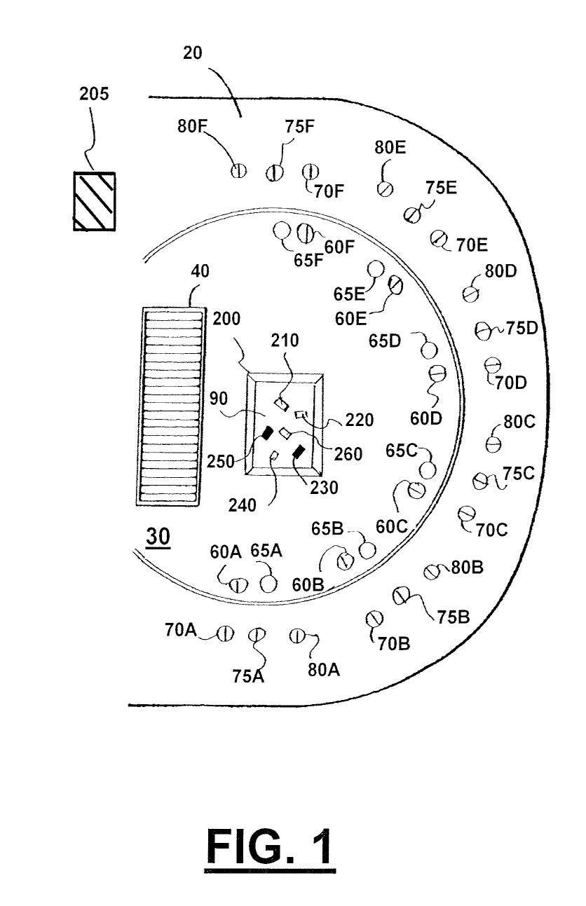

Referring to FIG. 1, table 20 can be a two legged in a half-moon shape and have a flat playing surface 30. The actual form of such a table (whether semi-circular, square, etc.) can vary, table 20 mainly serving to support the layout at a height which is suitable for the players. Area 40 is an area for housing the chips/counters prior to being used by the players. Surface 30 provides a playing surface marked with indicia 60, 65, 70, 75, and 80 to define the areas wherein various wagers can be made. Some or all of the areas can include a dividing line to specify the type of wager made in that area. For example area 60 includes a dividing line to allow the wager to be “most black” or “most white” Symbol 60 identifies the area for a most black/most white wager. A dividing line is included in this area to allow up to two choices—“most black” or “most white.” Symbol 65 identifies the area for a tie between black and white wager. Symbol 70 identifies the area for an odd/even wager. A dividing line is included in this area to allow up to two choices—“odd” or “even.” Symbol 75 identifies the area for an all black/all white wager. A dividing line is included in this area to allow up to three choices—“all black”; “all white”; or “either all black or all white.” Symbol 80 identifies the area for a proposition wager. One or more dividing lines can be included in this area to allow various choices for proposition wagers on the specific outcome of the shaken plates.

Table 20 can also include an area 90 for receiving shake plate 200.

In Shake Plate the object of the game is to make winning wagers on a random outcome of tile faces. There can be a house payment schedule listing a series of outcomes with corresponding pay-offs which apply to one or more of the wagers.

The Play

At the start of each game and prior to the shaking of shake plate 200, all players place their wagers, preferably in the form of chips, in their chosen wagering areas 60, 65, 70, 75, and 80. Preferably, each player is allowed to make a wager in only one chosen area 60, 65, 70, 75, and 80. However, alternative versions of the game can allow a player to make simultaneous wagers in two or more areas—for example one wager in the most black 60 area and a second wager in the odd number of black area 70. Preferably, rules would not allow players to make inconsistent simultaneous wagers—for example, a wager in the all black area 75 and a second wager in the most white area 60. Alternatively, inconsistent simultaneous wagers can be allowed.

The shaker places selected tiles (e.g., tiles 210, 220, 230, 240, 250, and 260) into shake plate 200, covers shake plate 200 with cover 205, and shakes shake plate 200. Each of the tiles 210, 220, 230, 240, 250, and 260 can have one side of one indicator (e.g., black or some other indicator) and a second side of a second indicator (e.g., while or some other indicator), the second indicator being distinct from the first indicator. The cover 205 is removed to reveal the result.

In FIG. 1, tiles 230 and 250 are black and tiles 210, 220, 240, and 260 are white. Accordingly, any wagers in most white (area 60) and even black/white (area 70) would win. Any wagers in most black (area 60), tie (area 65), odd black/white (area 70), all black/all white (area 75) would lose. Depending on the particular proposition wager (area 80) this result may be a win or a lose.

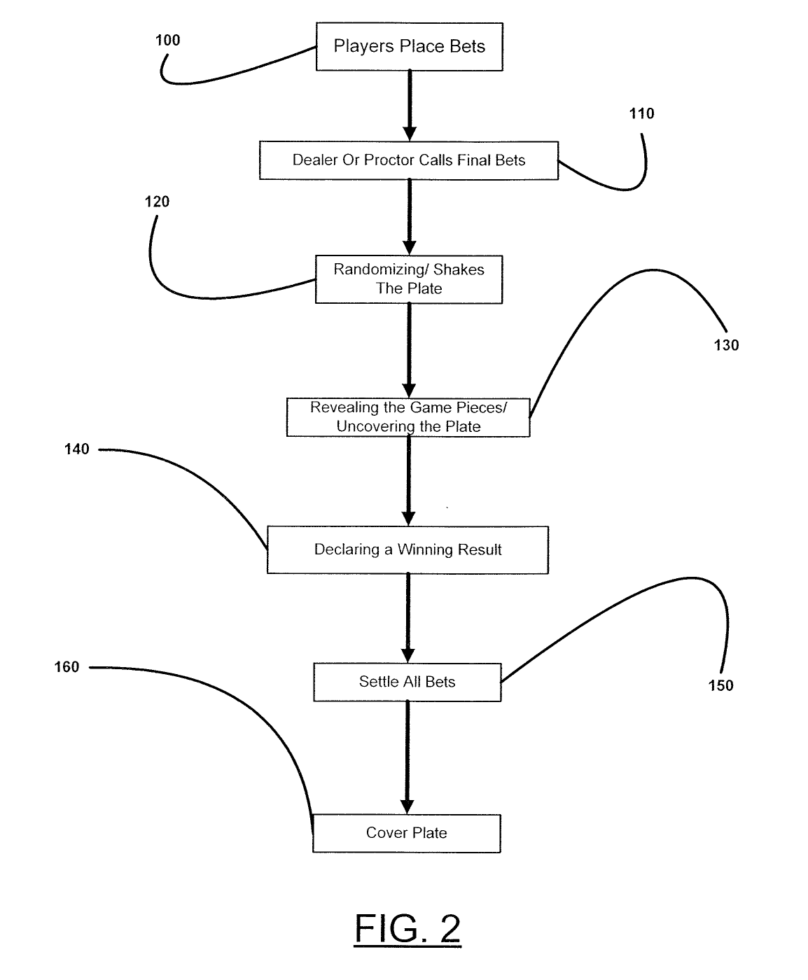

FIG. 2 illustrates a preferred embodiment of the method. In step 100 the players place bets. In this step the tiles can be prepared and/or shaken as long as the result is not revealed. Alternatively, the tiles can be shaken only after final bets are made.

In step 110 final bets are called for and all players can place their chosen wagers.

In step 120 the shaker can shake plate 200 to obtain a random result for the tiles 210, 220, 230, 240, 250, and 260. In step 130 the dealer or someone else can remove cover 205 and reveals the tile result of the round.

In step 140 a winning result can be declared, such as orally.

In step 150 all winning and losing bets can be settled.

In step 160 shake plate 200 can be covered with cover 205 for the next round of play, which next round can follow again steps 100 through 160.

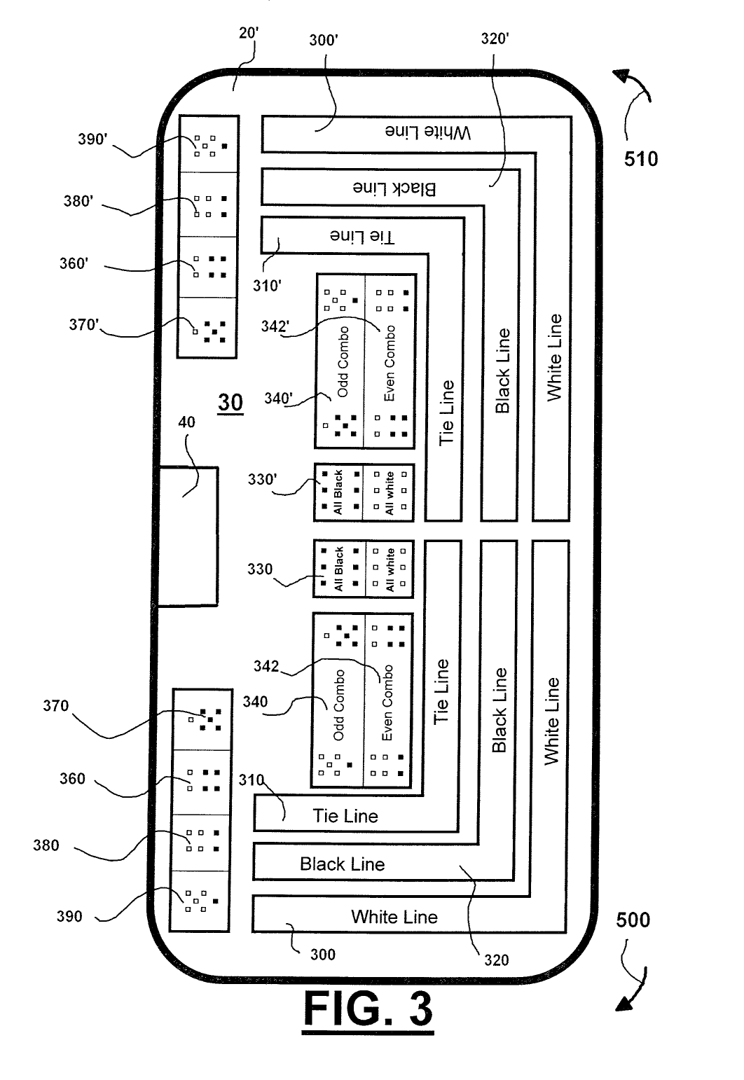

FIG. 3 shows an alternative table 20′ for game play. This alternative table includes various wager areas which include an area for white wager 300, area for tie wager 310, area for black wager 320, area for all black/all white wager 330, area for odd/even wager 340, area for tie wager 350, area for proposition wager (4 black/2 white) 360, area for proposition wager (5 black/1 white) 370, area for proposition wager (2 black/4 white) 380, and area for proposition wager (1 black/5 white) 390. A second set of wagering areas on table 20′ can include area for all black/all white wager 330′, area for odd/even wager 340′, area for tie wager 350′, area for proposition wager (4 black/2 white) 360′, area for proposition wager (5 black/1 white) 370′, area for proposition wager (2 black/4 white) 380′, and area for proposition wager (1 black/5 white) 390′. Areas 330′, 340′, 350′, 360′, 370′, 380′, and 390′ include the same bets as in their respective non-primed identified areas (but are included to give the players an option of where to place their bets depending on where the player is located in relation to table 20′). Areas 350 and 350′ are the same bet as area 310. Additional, different, or fewer proposition wager areas can be included for areas 360, 370, 380, and 390 along with their primed areas (such as where more than six tiles are used).

Arrows 500 and 510 schematically indicate that the wager areas in an alternative embodiment can be rotating slightly to face center area 40 to concentrate the players' attention on the randomization event (e.g., the shaking of the tiles).

Referring to a preferred embodiment of the method, Table A can be generated illustrating the potential pay-offs in relation to the list of outcomes applicable to the game. The house advantage is achieved because a difference exists between the true mathematical odds and the actual pay-off ratios. Those of ordinary skill in the art can calculate appropriate payoffs for a house advantage. The game can be played by offering odds/pay-offs of a higher or lower order resulting in different edges accruing to the house.

TABLE A
PAYOFFS

| Winning Wager | Pay Table |
|---|---|
| Odd/Even | 1 to 1 |
| black/white wager | calculated to give house odds, which can |
| | increase where the discrepancy increases |
| tie wager | calculated to give house odds |
| odd/even wager | calculated to give house odds |
| all black/all white | calculated to give house odds |
| proposition wager | calculated to give house odds |

The following is a Table of Probability and Payout for one preferred embodiment.

| Bet | Probability | Adv. % | Payout |
|---|---|---|---|
| All | 1.5625 | 4.69% | 60-1 |
| Black/White | | | |
| Odd Combo | 9.3750 | 6.25% | 4-1 |
| Even Combo | 23.4375 | 3.13% | 1-1 |

| Black | White | Adv. % | Payout |
|---|---|---|---|
| 4 | 2 | 6.25% | 3-1 |
| 2 | 4 | 6.25% | 3-1 |
| 5 | 1 | 6.25% | 9-1 |
| 1 | 5 | 6.25% | 9-1 |

| Black | White | Winning | Line Bet |
|---|---|---|---|
| Tiles | Tiles | Line | Payout |
| 0 | 6 | White | 6-1 |
| 1 | 5 | White | 3-1 |
| 2 | 4 | White | 1-1 |
| 3 | 3 | Loss | 0 |
| 4 | 2 | Black | 1-1 |
| 5 | 1 | Black | 3-1 |
| 6 | 0 | Black | 6-1 |

The method and apparatus can be adapted and played on a video game machine. Simulated cards are exposed electronically on a display panel/screen. Different rules for playing the game can be applied. In the above examples the pay-table can be adjusted to reflect the probabilities. It is to be understood that the embodiments discussed herein is merely illustrative of the application of the principles of the invention. Numerous modifications may be made therein and other arrangements may be devised without departing from the spirit and scope of the invention.

The following is a list of reference numerals:

LIST FOR REFERENCE NUMERALS

| (No.) | (Description) |
|---|---|
| 10 | method |
| 20 | table |
| 30 | surface of table |
| 40 | area for chips |
| 60 | area for black/white wager |
| 65 | area for tie wager |
| 70 | area for odd/even wager |
| 75 | area for all black/all white |
| 80 | area for proposition |
| 90 | randomizing area |
| 100 | placing of wagers |
| 110 | calling for last bet |
| 120 | randomizing (preparing/shaking shake plate) |
| 130 | showing tile result |
| 140 | declaring one or more winners |
| 150 | settling all wagers |
| 160 | cover shake plate for next round |
| 200 | shake plate |
| 205 | cover for shake plate |
| 210 | tile |
| 220 | tile |
| 230 | tile |
| 240 | tile |
| 250 | tile |
| 260 | tile |
| 300 | area for white wager |
| 310 | area for tie wager |
| 320 | area for black wager |
| 330 | area for all black/all white wager |
| 340 | area for odd/even wager |
| 350 | area for tie wager |
| 360 | area for proposition wager (4 black/2 white) |
| 370 | area for proposition wager (5 black/1 white) |
| 380 | area for proposition wager (2 black/1white) |
| 390 | area for proposition wager (1 black/5 white) |
| 500 | arrow |
| 510 | arrow |

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

1. A method of playing a casino game comprising the steps of:
(a) requiring each player to place a wager to participate in a wagering game played against the house/bank;
(b) wherein the wagers are chosen based on an outcome from a random event based on a set of tiles;
(c) supplying a set of tiles, each having at least two possible indicia;
(d) randomizing the set of tiles;
(e) based on the outcome of step “d” a comparison being made between each player's wager and the outcome; and
(f) paying each winning player.

2. The method of claim 1, wherein the number of tiles are six.

3. The method of claim 1, wherein the number of tiles are between two and 25.

4. The method of claim 1, wherein the amount of each player's wager is predetermined by house rules.

5. The method of claim 1, wherein in step “a” the wagers are chosen from the set including: (i) tie between black and white; (ii) black being greater than white; (iii) white being greater than black; (iv) specific odd number of blacks or odd number of whites; (v) specific even number of blacks or even number of whites; (vi) all black; (vii) all white; and (viii) a set of specific proposition of possible black and white outcomes.

6. The method of claim 7, wherein the specific proposition outcomes do not overlap with the other possible wagers in the set.

7. The method of claim 1, wherein in step “a” the wagers are chosen from the set including: (i) tie between black and white; (ii) black being greater than white; (iii) white being greater than black; (iv) specific odd number of blacks or odd number of whites; (v) specific even number of blacks or even number of whites; (vi) all black or all white; and (viii) a set of specific proposition of possible black and white outcomes.

8. The method of claim 1, wherein in step “a” the wagers are chosen from the set including: (i) tie between black and white; (ii) black being greater than white; (iii) white being greater than black; (iv) even number of whites; (v) odd number of whites; (vi) even number of blacks; (vii) odd number of blacks; (viii) all black; (ix) all white; and (x) a set of specific proposition of possible black and white outcomes.

9. The method of claim 1, wherein in step “a” each player is allowed to make more than one wager.

10. The method of claim 8, wherein the payout of step “f” increases for wagers (ii) and (iii) where the discrepancy between black and white increases.

11. A method of playing a casino game comprising the steps of:
(a) requiring each player to place a wager to participate in a wagering game played against the house/bank;
(b) wherein the wagers are chosen based on an outcome from a random event based on a set of game pieces;
(c) supplying a set of game pieces, each having two possible outcomes—a first indicia outcome and a second indicia outcome;
(d) randomizing the set of game pieces;
(e) based on the outcome of step “d” a comparison being made between each player's wager and the outcome; and
(f) paying each winning player.

12. The method of claim 11, wherein the number of game pieces is six.

13. The method of claim 11, wherein the game pieces are tiles.

14. The method of claim 11, wherein in step “a” the wagers are chosen from the set consisting of (i) tie between the first indicia and second indicia; (ii) greater first indicia outcome; (iii) greater second indicia outcome; (iv) specific odd combination of the first or second indicia outcomes; (v) specific even combination of the first or second indicia outcomes; (vi) all first indicia outcomes; and (vii) all second indicia outcomes.

15. The method of claim 11, wherein in step “a” the wagers are chosen from the set consisting of (i) tie between the first indicia and second indicia; (ii) greater first indicia outcome; (iii) greater second indicia outcome; (iv) specific odd combination of the first or second indicia outcomes; (v) specific even combination of the first or second indicia outcomes; (vi) all first indicia outcome; (vii) all second indicia outcome; and (viii) specific proposition outcomes of first and second indicia for the game pieces.

16. The method of claim 14, wherein the specific proposition outcomes do not overlap with the other possible wagers in the set.

17. The method of claim 15, wherein the specific proposition outcomes do not overlap with the other possible wagers in the set.

18. The method of claim 15, wherein the payout of step “f” increases for wagers (ii) and (iii) where the discrepancy between first and second indicia increases.

19. The method of claim 11, further comprising the step of (g) providing a game table.

20. The method of claim 11, wherein the game pieces are two sided cards or tiles, one side of each game piece being white and the other side being black.

21. The invention as substantially shown and described.
